(19) United States
(12) Patent Application Publication
(10) Pub. No.: US 2003/0021625 A1
(43) Pub. Date: Jan. 30, 2003

(54) Interconnection of two wood beams that are joined together while forming an at least approximately right angle

(76) Inventor: Paul Mattle, Widnau (CH)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/220,112

(22) PCT Filed: Feb. 20, 2001
(86) PCT No.: PCT/EP01/01861

(30) Foreign Application Priority Data
Feb. 29, 2000 (DE) 200 03 705.6

(51) Int. Cl. B25G 3/00; F16B 7/08; F16L 41/00

(52) U.S. Cl. 403/230

(57) ABSTRACT

In order to effect an interconnection of two wood beams (1, 2) that are joined together while forming an at least approximately right angle, screws (3) are provided which engage inside both wood beams (1, 2). To this end, at least two screws (3) are inserted which are arranged in two planes running parallel to one another and which are screwed in such that they cross. In one of the beams (2), screws (3) are inserted in planes that are parallel to the grain and thus engage in the other beam (1) at a right angle or acute angle to the grain.

The invention relates to an interconnection between two wood beams which are joined at least approximately at right angles and which are provided with screws engaging both wood beams.

There are already known many varied embodiments of wood interconnections by means of screws (DE 706759C and FR 865 513). In these known wood interconnections, screws are screwed in at an acute angle to the surface of such beams, while usually little attention is paid to the true loading problems of wood interconnections. Therefore, such wood interconnections have evidently not received practical acceptance. Problems arise especially with perpendicularly adjoining wood beams, which until now could be reliably interconnected in practice only by an adequate tongue-and-groove joint, if appropriate with additional use of adhesives and with the aid of metal profile elements.

The present invention has the object of providing an interconnection of the initially described type, which enables optimal force transmission by the use of screws.

Such interconnections are advantageously applicable to the connection of main/auxiliary bearing members. Of the two screws which are each used in pairs, one can bear the load in tension, the other the load in compression. Appropriate tests demonstrate that substantially better results are achieved even when only screws are used, i.e. no supplemental interlocking tongues and grooves are present.

At the location of an auxiliary bearing member, sufficient anchoring of the screws is possible in planes which are parallel to the grain; at the location of the main bearing member there also exists sufficient anchoring, because there the screws extend transversely to the grain.

Thus, it is a very significant feature of the present invention that the screws are inserted in planes which lie parallel to each other, with these planes extending in one wood beam parallel to the grain and in the other wood beam transversely to the grain.

This not only enables adequate mutual attachment, but it also yields optimum force transmission between the two wood beams which are to be connected to each other.

It is further proposed that more than two screws each lie in planes which are oriented parallel to each other and that the screws which lie in consecutive planes are respectively screwed-in from opposite directions and therefore cross each other. This means that the head of one screw is oriented toward one wood beam and the head of another screw toward the other wood beam. In this way, the respective operating compression and tension forces can be controlled even substantially better.

It is further proposed that the screws are screwed in respectively in planes extending parallel to each other and in one of two planes which extend at right angles to those, with the two planes which extend at right angles to the other planes enclosing between them a right angle or an angle which differs slightly from a right angle. Therefore, the screws located in consecutive planes are oriented parallel to each other relative to one plane and respectively cross each other relative to the other planes. This yields optimism force transmission, with the ability to insert even in relatively small wood beams either only two or a multiplicity of screws which are present in the same orientation in the consecutive planes.

It is especially advantageous if the two planes which are oriented approximately at a right angle to each other and with it those screws which are oriented in conformity with those planes cross each other in the vicinity of the place of abutment between the adjoining wood beams. In this way, the principal transmission of forces of the wood beams to be interconnected are concentrated at their confronting surfaces, so that here, too, these forces operate essentially in the central portion relative to the height of at least the wood beam having the smaller cross-section That is the reason why optimum force transmission is possible. It is also why destruction of the wood beam under load is virtually impossible. The interconnection is thus based on the ability of the screws to absorb tension and compression forces, so that substantially higher values can be achieved than with an exclusively tongue and groove connection or through nail interconnections Therefore, it can be regarded as especially desirable that the two planes oriented approximately at right angles to each other and with it the screws oriented in conformity with these planes cross each other at approximately one-half the height of the beam or at the height of the smaller beam. This also makes possible the optimum interconnection of two wood beams at approximately right angles to each other

Further inventive features and special advantages are described in more detail in the following description with reference to the drawings. There is shown in:

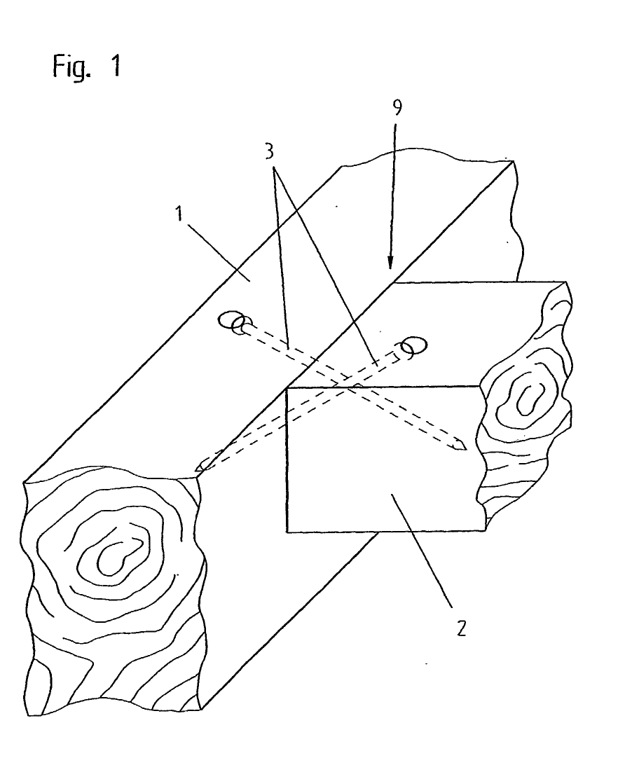

FIG. 1 a diagonal view of two wood beams which are connected to each other at at least approximately a right angle;

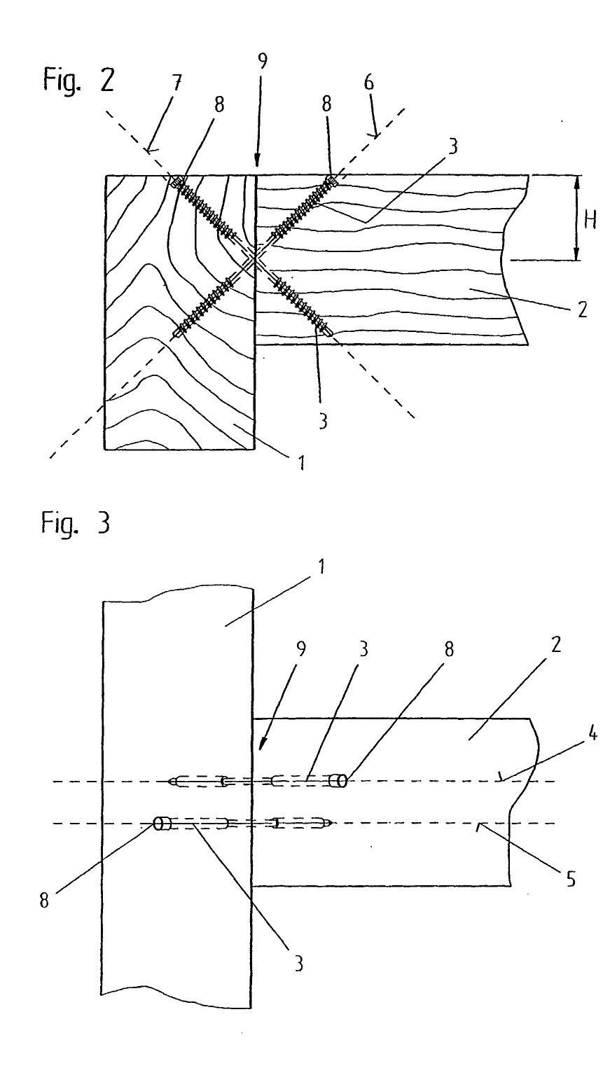

FIG. 2 a vertical cross-section through this interconnection;

FIG. 3 a top view of the wood beams to be connected to each other;

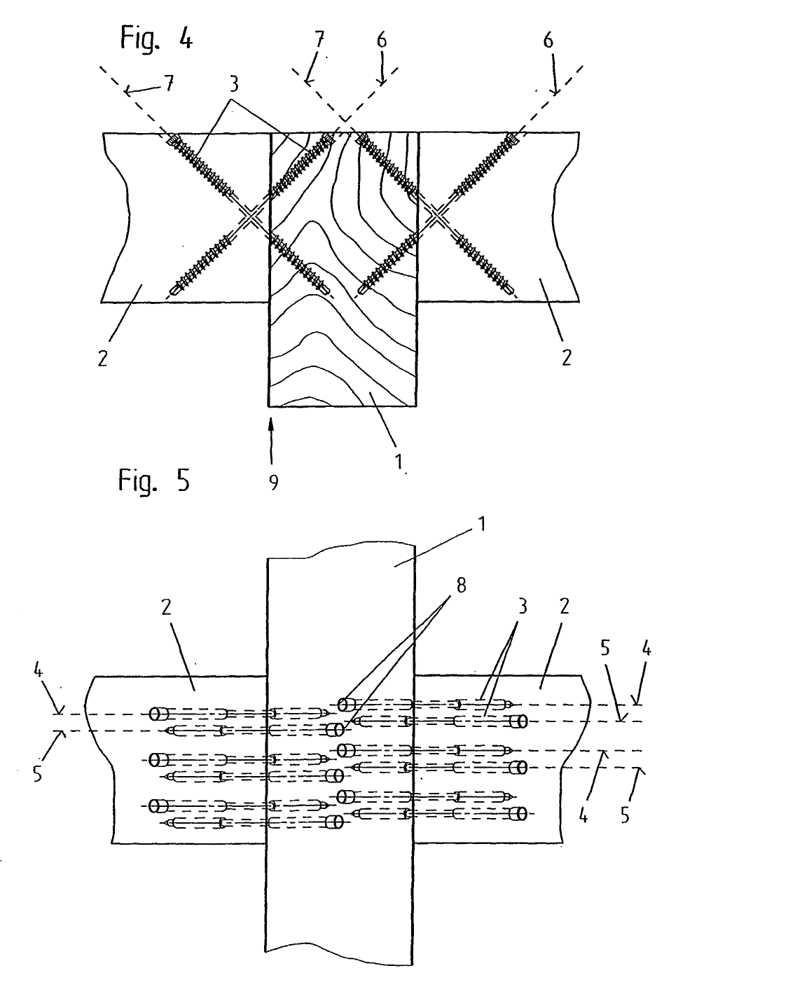

FIG. 4 and FIG. 5 a vertical cross-section as well as a top view of an alternative embodiment, in which a wood beam forming a main bearing member is connected at right angles to two oppositely located wood beams.

The present invention involves the interconnection of two wood beams 1 and 2 which adjoin each other at at least approximately a right angle, namely by using wood screws 3 which have thread segments engaged in both wood beams 1 and 2.

Such interconnections are customary when there is present a wood beam 1 designated as a main bearing member and of larger cross-section, to which there are connected wood beams 2 designated as auxiliary bearing members and of smaller cross-section. Within the scope of the invention it is of course basically possible to employ such a connection wherever there are present wood beams 1 and 2 joined at approximately a right angle to each other, it being fundamentally immaterial whether both wood beams 1 and 2 have the same height or even the same cross-section or whether optionally the cross-section of wood beam 2 is larger than the cross-section of wood beam 1.

In the embodiment of FIGS. 2 and 3, two screws 3 are inserted. These two screws 3 lie in planes 4 and 5 extending parallel to each other, so that the screws 3 in the one wood beam 1 are engaged at a right or acute angle to the grain and, in the other wood beam 2 this plane 4, or 5 extends parallel to the grain. Further, the screws 3 lie in planes 6 or 7 respectively, which extend at a right angle to planes 4 and 5 so that the screws 3 are screwed in crossing each other but in the spaced-apart planes 4 and 5.

The two planes 6 and 7 are located approximately at a right angle to each other so that the screws 3 are also screwed in crossing approximately at a right angle. It is also arranged that the screws 3 lying in the consecutive planes 4 and 5 are screwed in from opposite directions so that in one case the head 8 of a screw 3 is oriented toward the wood beam 2 and in one case toward the wood beam 1.

From this arrangement of screws 3 it also follows that the two planes oriented at approximately a right angle to each other, and therefore of course also the screws 3 oriented in conformity with these planes 6 and 7, cross each other in the vicinity of the abutment location 9 of the adjoining wood beams 1, 2. In so doing, it is advantageous that these two planes 6 and 7 and therefore also the screws 3 lying therein cross each other at approximately one-half the height of the beams 1 or 2 respectively, or in the present case at one-half the height of the beam 2 having the lesser height. As a result, upon corresponding loading of wood beams land 2, the region of greatest force transfer between the two beams is concentrated in the middle region of the height of beam 2, which is the very reason why optimum force transfer is made possible.

In the embodiment according to FIGS. 4 and 5, essentially the same conditions are established as for the embodiment according to FIGS. 2 and 3, namely, on the one hand, several pairs of screws 3 are inserted as interconnection between the wood beams 1 and 2 and, on the other hand, the possibility is indicated here that wood beams 2 located opposite each other can be connected at an approximately right angle with a wood beam 1 forming a main bearing member. This requires only an appropriately displaced arrangement of planes 4 and 5. It is further conceivable to position the pairs of screws 3 associated with the oppositely located wood beams 2 displaced slightly with respect to each other.

In the foregoing description, it was always assumed that the wood beams 2 abut flat against wood beam 1. However, it would be readily possible, in addition to known tongue and groove connections, to utilize screws in the inventive manner in order to achieve optimum mutual connection. In so doing, screws can be inserted which exhibit two thread segments as in the illustrated embodiment, namely one located toward the screw tip and the other toward the screw head. However, it is also possible to provide a continuous thread. Furthermore, screws can be utilized in which two screw segments are provided with different thread pitches, thereby also achieving a mutual compression force between the wood beams 1 and 2. The screws illustrated in the drawings exhibit a kind of boring portion in order to reduce the risk of splitting the wood beams during screwing in of the screws. Within the scope of the invention, one can also contemplate using screws 3 in which the thread segments have different diameters such that the thread segment which is located toward the head of the screw has a slightly larger diameter.

1. Interconnection between two wood beams adjoining each other at least approximately at a right angle, having screws engaged in both wood beams, characterized in that there are inserted at least two screws (3) lying in two parallel-extending planes (4, 5) which are screwed-in crossing each other, with the screws (3) being inserted in the one beam (2) in planes (4, 5) which extend parallel to the grain and therefore engage the other beam (1) at a right or acute angle to the grain.

2. Interconnection according to claim 1, characterized in that more than two screws (3) each lie in planes (4, 5) oriented parallel to each other and the screws (3) lying in consecutive planes (4, 5) are respectively screwed-in from opposite directions and therefore respectively cross each other.

3. Interconnection according to claim 1 or 2, characterized in that the screws (3) are each screwed-in in planes (4, 5) extending parallel to each other and in one of two planes (6, 7) extending at right angles to those, with the two planes (6, 7) extending at right angles to the other planes (4, 5) enclosing between them a right angle or an angle which differs slightly from a right angle.

4. Interconnection according to one of claims 1 to 3, characterized in that the two planes (6, 7) which extend at least approximately perpendicularly to each other and therefore the screws (3) which are oriented in conformity with these planes (6, 7) cross each other in the region of abutment (9) of the wood beams (1, 2) adjoining each other.

5. Interconnection according to one of claims 1 to 4, characterized in that the two planes (6, 7) which extend at least approximately perpendicularly to each other and with it the screws (3) oriented in conformity with these planes (6, 7) cross each other approximately at one-half the height (H) of the beams (1, 2) or of the height of the smaller beam (2).
